(19) United States
(12) Patent Application Publication
(10) Pub. No.: US 2025/0258469 A1
(43) Pub. Date: Aug. 14, 2025

(54) STANDBY ENTITY FOR HARDWARE FUNCTIONS

(71) Applicant: Infineon Technologies AG, Neubiberg (DE)

(72) Inventors: Ekaterina Vlasova, München (DE); Jens Rosenbusch, München (DE); Mohanish Arun Nehete, München (DE)

(21) Appl. No.: 19/038,768

(22) Filed: Jan. 28, 2025

(30) Foreign Application Priority Data
Feb. 9, 2024 (DE) 10 2024 201 184.3

(51) Int. Cl. G05B 19/042

(52) U.S. Cl. CPC G05B 19/042; G05B 2219/23316; G05B 2219/25257

(57) ABSTRACT

An electronic device comprises a plurality of non-programmable hardware elements, each non-programmable hardware element being configured for providing at least one non-programmable function; at least one programmable hardware element configured for providing at least one programmable function, wherein the programmable hardware element comprises at least one standby entity, wherein the standby entity is configured for providing at least one programmable function for replacing the non-programmable functions of at least two non-programmable hardware elements; and at least one arbiter configured for deactivating at least one non-programmable hardware element and for activating the standby entity for replacing at least one non-programmable function provided by the non-programmable hardware element with at least one programmable function.

### REFERENCE TO RELATED APPLICATIONS

This application claims priority to German Patent Application 10 2024 201 184.3, filed on Feb. 9, 2024, the contents of which are hereby incorporated by reference in their entirety.

### TECHNICAL FIELD

The present disclosure relates to an electronic device, an embedded system comprising the electronic device and a method for operating the electronic device.

### BACKGROUND

Several applications typically require tolerances for hardware failures or a high availability of components for critical functions within a system. Otherwise, a failure of one component of the system may lead to a failure of the entire system which may in turn cause severe damage, potentially also to humans, such as in an automotive application. One option to prevent this may be a complete duplication of all components in order to provide a redundancy for every component. However, such a duplication may result in a corresponding increase in costs, such as production costs. Further, power consumption may increase. There typically also is a high cost associated with an exchange of components, specifically in highly integrated systems. In such highly integrated systems, such as in a system on a chip (SoC), an available area, such as a chip area, may further be limited. Thus, duplicating components may also result in less available area for other components and eventually in performance limitations of the system. Further, specifically in highly integrated systems, there typically is less access to components. Some components may even be completely inaccessible, such that they cannot be physically reached from outside at all.

### SUMMARY

In a first aspect, an electronic device is presented. The electronic device comprises a plurality of non-programmable hardware elements. Each non-programmable hardware element is configured for providing at least one non-programmable function. The electronic device further comprises at least one programmable hardware element. The programmable hardware element is configured for providing at least one programmable function. The programmable hardware element comprises at least one standby entity. The standby entity is configured for providing at least one programmable function for replacing the non-programmable functions of at least two non-programmable hardware elements. The electronic device further comprises at least one arbiter. The arbiter is configured for deactivating at least one non-programmable hardware element. The arbiter is further configured for activating the standby entity for replacing at least one non-programmable function provided by the non-programmable hardware element with at least one programmable function.

In a further aspect, an embedded system is presented. The embedded system comprises at least one electronic device. The electronic device comprises a plurality of non-programmable hardware elements. Each non-programmable hardware element is configured for providing at least one non-programmable function. The electronic device further comprises at least one programmable hardware element. The programmable hardware element is configured for providing at least one programmable function. The programmable hardware element comprises at least one standby entity. The standby entity is configured for providing at least one programmable function for replacing the non-programmable functions of at least two non-programmable hardware elements. The electronic device further comprises at least one arbiter. The arbiter is configured for deactivating at least one non-programmable hardware element. The arbiter is further configured for activating the standby entity for replacing at least one non-programmable function provided by the non-programmable hardware element with at least one programmable function. The embedded system further comprises at least one further device controlled by the electronic device.

In a further aspect, a method for operating at least one electronic device is presented. The method comprises the following acts performed by using an arbiter of the electronic device: deactivating a non-programmable hardware element of the electronic device; and activating a standby entity of a programmable hardware element of the electronic device for replacing at least one non-programmable function provided by the non-programmable hardware element with at least one programmable function provided by the standby entity.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates an exemplary embodiment of an electronic device according to the present disclosure in a highly schematic fashion;

FIG. 2 illustrates an exemplary embodiment of an embedded system according to the present disclosure in a highly schematic fashion;

FIGS. 3 and 4 illustrate specific exemplary embodiments of the electronic device in a highly schematic fashion; and

FIG. 5 illustrates a flow chart of an exemplary embodiment of a method for operating an electronic device according to the present disclosure.

### DETAILED DESCRIPTION

In a first aspect, an electronic device is presented. The term “electronic device” as generally used herein is a broad term and is to be given its ordinary and customary meaning to a person of ordinary skill in the art and is not to be limited to a special or customized meaning. The electronic device may be a device using electrical energy during operation. The electronic device may be or may comprise at least one electronic circuit. The electronic device may comprise at least one electronic component, which may be connected to at least one further electronic component. The electronic device may be an assembly of at least two electronic components, which are at least partially interconnected through conductive elements. The electronic device may comprise at least one interconnect. The interconnect may be configured for at least partially interconnecting electronic components of the electronic device. As an example, the electronic components may comprise resistors, inductors, capacitors, diodes and/or transistors and/or assemblies thereof such as logic gates and/or processors. As an example, the conductive elements may comprise wires and/or traces. Specifically, the electronic device may be or may comprise at least one integrated circuit. Thus, the electronic device or at least a part of the electronic device may be arranged on at least one piece of semiconductor material, specifically silicon, silicon carbide and/or gallium nitride. Thus, the electronic device may be or may comprise at least one semiconductor device. The semiconductor device may be a device comprising at least one semiconductor material, specifically silicon, silicon carbide and/or gallium nitride. Thus, the electronic device may be or may comprise at least one of a system on a chip (SoC) and a system in a package (SiP).

The electronic device may be a microcontroller. The electronic device may be a part of a microcontroller. The electronic device may comprise at least one microcontroller. The term “microcontroller” as generally used herein is a broad term and is to be given its ordinary and customary meaning to a person of ordinary skill in the art and is not to be limited to a special or customized meaning. The microcontroller may be a computing device comprising at least one integrated circuit, specifically exactly one integrated circuit. The microcontroller may be configured for controlling or monitoring or regulating at least one further device, specifically within an embedded system. The microcontroller may be configured for fulfilling at least one application related function or task, specifically within the embedded system. As an example, the microcontroller may comprise at least one processor and at least one input/output interface. Further options are feasible. Specifically, the microcontroller may comprise further components such as at least one hardware accelerator and/or at least one memory.

The electronic device comprises a plurality of non-programmable hardware elements. The electronic device further comprises at least one programmable hardware element. The term “programmable”, or any grammatical variation thereof, as generally used herein is a broad term and is to be given its ordinary and customary meaning to a person of ordinary skill in the art and is not to be limited to a special or customized meaning. The term “programmable” may refer to an ability of an entity to be programmed or configured with at least one instruction, specifically with at least one set of instructions, which the entity can then execute automatically or at least partially automatically, such as for performing at least on function. In other words, a programmable entity may be configured for being programmed with a set of instructions for performing at least one function, specifically for allowing the entity to adapt to changing requirements. A programmable entity may be configured for being programmed by using a variety of tools, such as software tools, e.g. software programs, or hardware tools, e.g. programmable logic devices. In other words, a programmable entity may be configured for being software programmed or hardware programmed. Thus, being programmable may comprise being at least one of software programmable and hardware programmable.

The term “hardware” as generally used herein is a broad term and is to be given its ordinary and customary meaning to a person of ordinary skill in the art and is not to be limited to a special or customized meaning. Hardware may comprise at least one arbitrary physical component of a data processing system. Specifically, hardware may comprise at least one electrical component, such as an electrical component ranging from a single transistor to an entire printed circuit board (PCB). In principle, hardware may also comprise at least one mechanical component of the data processing system. The term “software” as generally used herein is a broad term and is to be given its ordinary and customary meaning to a person of ordinary skill in the art and is not to be limited to a special or customized meaning. Software may comprise non-physical information. Software may comprise at least one element of information. Software may comprise data and/or instructions, specifically software programs.

Hardware may be configured for executing software and thus for converting it into actions, specifically into physical actions. A hardware element, specifically a programmable hardware element, may comprise software, specifically in a sense that the hardware element may comprise an electrical component having software installed on it and/or having software being executed on it. As an example, a central processing unit (CPU) as a hardware element may have a variety of software programs installed on it and may execute at least a part of the installed software programs. The CPU may be a central processor or a main processor of an entity, specifically of the electronic device. As a remark, an entity, such as the electronic device, may comprise at least one CPU, i.e. one CPU or also more than one CPU. As a further remark, the CPU may of course also be configured for installing and potentially executing even further software programs on it. Thus, the CPU may specifically be software programmable.

The term “software programmable”, or any grammatical variation thereof, as generally used herein is a broad term and is to be given its ordinary and customary meaning to a person of ordinary skill in the art and is not to be limited to a special or customized meaning. The term “software programmable” may refer to an ability of an entity to be programmed by using software, specifically software programs. A software program may comprise a set of instructions written in a programming language. Programming languages may comprise machine code, assembly code or other low-level programming languages or also high-level programming languages. Software programming may further comprise a use of hardware, specifically of hardware for executing the software, e.g. a CPU for executing a software program. Thus, the term “software programmable” may refer to an ability of an entity to be programmed by using software and hardware. As an example, a programmable entity such CPU may be programmed, specifically software programmed, by installing a software program on the CPU, such that the CPU can execute the software program. For further details, reference may also be made to the definition of the term “programmable” above.

The term “hardware programmable”, or any grammatical variation thereof, as generally used herein is a broad term and is to be given its ordinary and customary meaning to a person of ordinary skill in the art and is not to be limited to a special or customized meaning. The term “hardware programmable” may refer to an ability of an entity to be programmed by using hardware, specifically by using hardware only, more specifically without using software. As an example, the term “hardware programmable” may refer to an ability of an entity to be programmed by using at least one programmable logic device (PLD). The PLD may be a configurable electric circuit, specifically a re-configurable digital circuit. The PLD may comprise at least one electronic circuit which, after a completion of a production of the electronic circuit, may still be programmable or configurable, e.g. by using fuses and/or anti-fuses and/or erasable programmable read only memory (EPROM). Specifically, the PLD may be or may comprise a field programmable gate array (FPGA). The FPGA may be or may comprise an integrated circuit designed for being programmed or configured after manufacturing. Thus, the term “hardware programmable” may specifically refer to an ability of an entity to be programmed by using at least one field programmable gate array (FPGA). As an example, a programmable entity such as a field programmable gate array (FPGA) may be programmed, specifically hardware programmed, by physically arranging or manipulating electric components, such as logic gates, of an electronic circuit, specifically of an integrated circuit. For further details, reference may also be made to the definition of the term “programmable” above.

The term “non-programmable”, or any grammatical variation thereof, as generally used herein is a broad term and is to be given its ordinary and customary meaning to a person of ordinary skill in the art and is not to be limited to a special or customized meaning. The term “non-programmable” may refer to a lack of the ability of an entity to be programmed with at least one instruction, specifically with at least one set of instructions, which the entity can then execute automatically or at least partially automatically, such as for performing at least one function. For further details, reference may also be made to the definition of the term “programmable” above. The term “re-programmable”, or any grammatical variation thereof, as generally used herein is a broad term and is to be given its ordinary and customary meaning to a person of ordinary skill in the art and is not to be limited to a special or customized meaning. The term “re-programmable” may refer to the ability of an entity to be programmed repeatedly, such as at least twice within an arbitrary time interval, with at least one instruction, specifically with at least one set of instructions, which the entity can then execute automatically or at least partially automatically, such as for performing at least one function. For further details, reference may also be made to the definition of the term “programmable” above.

The term “programmable hardware element” as generally used herein is a broad term and is to be given its ordinary and customary meaning to a person of ordinary skill in the art and is not to be limited to a special or customized meaning. The programmable hardware element may be a piece of hardware which is programmable. The programmable hardware element may comprise at least one processor, also referred to as processing unit. As indicated, the programmable hardware element may comprise software, such as a software programs installed on the processor. The processor may be hardware element configured for performing processing operations or computational operations, such as mathematical operation or logical operations. Specifically, the processor may be configured for performing at least one data processing operation according to at least one instruction. The programmable hardware element may be configured for addressing or accessing further hardware elements, specifically non-programmable hardware elements, such as a hardware accelerator, e.g. for performing such operations. The processor may be at least one of a central processing unit (CPU); a field programmable gate array (FPGA); a graphic processing unit (GPU) and a programmable state machine. Thus, the programmable hardware element may comprise at least one element selected from the group consisting of: a central processing unit (CPU); a field programmable gate array (FPGA); a graphic processing unit (GPU); a programmable state machine. Other options may be feasible.

The term “non-programmable hardware element” as generally used herein is a broad term and is to be given its ordinary and customary meaning to a person of ordinary skill in the art and is not to be limited to a special or customized meaning. The non-programmable hardware element may be a piece of hardware which is not programmable. The non-programmable hardware element may be or may comprise at least one peripheral of the electronic device. Thus, the non-programmable hardware element may be a non-central component of the electronic device, a central component being for instance a processor, e.g. a CPU. The non-programmable hardware element may be or may comprise at least one auxiliary hardware element of the electronic device, specifically an auxiliary hardware element to the programmable hardware element. The non-programmable hardware elements may be configured for providing at least partially different non-programmable functions. In other words, at least two non-programmable hardware elements may be configured for providing different non-programmable functions. Specifically, the non-programmable hardware elements may be selected from the group consisting of: a hardware accelerator; an input/output interface (IO interface). Thus, as an example, a first non-programmable hardware element may be hardware accelerator providing a hardware acceleration function. Further, a second non-programmable hardware element may be an IO interface providing an interface function. More specifically, the non-programmable hardware elements may be selected from the group consisting of: a serial peripheral interface (SPI); a universal asynchronous receiver transmitter (UART); a digital signal processor (DSP); a universal serial bus (USB); an inter-integrated circuit (I²C); a direct memory access (DMA). Other options may be feasible.

As indicated, at least one non-programmable hardware element may be a hardware accelerator. The term “hardware accelerator” as generally used herein is a broad term and is to be given its ordinary and customary meaning to a person of ordinary skill in the art and is not to be limited to a special or customized meaning. The hardware accelerator may be a hardware element configured for assisting, specifically for relieving, a programmable hardware element, such as a CPU, during operation by taking over at least one function from the programmable hardware element. The hardware accelerator may be specialized for performing this function. In contrast, the programmable hardware element may be configured in a universal fashion for performing a variety of different functions. Thus, the programmable hardware element may be less efficient in performing a specific function than the hardware accelerator which may be specialized on that specific function. Such a function may for instance be a parallelizable operation. Specifically, the hardware accelerator may be configured for relieving the programmable hardware element by taking over computationally intensive tasks from the programmable hardware element. Thus, the hardware accelerator may be configured for data processing, specifically without using software, such as software programs.

As further indicated, at least one non-programmable hardware element may be an input/output interface (IO interface). The term “input/output interface”, short “IO interface”, as generally used herein is a broad term and is to be given its ordinary and customary meaning to a person of ordinary skill in the art and is not to be limited to a special or customized meaning. The IO interface may be or may comprise a communication interface between an entity and an outside world. Thus, the IO interface may be or may comprise a communication interface between at least two entities. Specifically, the IO interface may be a communication interface between the electronic device and at least one further device, such as a device controlled by the electronic device, specifically within an embedded system. The IO interface may be configured for transferring data and/or instructions from a first entity to a second entity, specifically from the electronic device to at least one further device, more specifically from the programmable hardware element of the electronic device to at least one further device. The IO interface may be configured for wired and/or wireless transfer of data and/or instructions. The IO interface may be configured for implementing at least one protocol for a communication between at least two entities. The IO interface may be configured for converting and/or decoding and/or encoding data formats of the data being transferred. Thus, the IO interface may be configured for data processing, specifically without using software, such as software programs. The IO interface may comprise at least one pin. The pin may be configured for being contacted by at least one conductive element comprised by a further device or system.

Each non-programmable hardware element is configured for providing at least one non-programmable function. The programmable hardware element is configured for providing at least one programmable function. The term “programmable function” as generally used herein is a broad term and is to be given its ordinary and customary meaning to a person of ordinary skill in the art and is not to be limited to a special or customized meaning. A programmable function may be a variable or modifiable or configurable function or task. Specifically, the programmable function may be configurable at least once by using programming, such as software programming and/or hardware programming. The programmable function may be implemented by using software and/or at least one programmable hardware element. The programmable function may be at least one of a software function and a hardware function. A software function may for instance be modified by updating a software program. In this case, the hardware function may specifically be a programmable hardware function. There may also be non-programmable hardware functions as will be outlined in further detail below. A hardware function may for instance be modified by re-arranging electronic components or connections between electronic components in a hardware element, specifically in a programmable hardware element, or by changing electronic properties of the electronic components, such as in an FPGA. A software function may for instance be modified by updating a software program or by programming or re-programming a programmable hardware element, e.g. a CPU.

The term “software function” as generally used herein is a broad term and is to be given its ordinary and customary meaning to a person of ordinary skill in the art and is not to be limited to a special or customized meaning. A software function may be a function or a task performed by using software, such as at least one software element, specifically a software program. Additionally to software, a software function may also be performed by using hardware, specifically a programmable hardware element, e.g. a CPU, for executing the software. As an example, the software function may specifically be or may comprise a software program. The term “hardware function” as generally used herein is a broad term and is to be given its ordinary and customary meaning to a person of ordinary skill in the art and is not to be limited to a special or customized meaning. A hardware function may be a function or a task performed by using at least one hardware element, such as a non-programmable hardware element. Thus, a hardware function may specifically be performed without using software, such as software programs. As an example, the hardware function may be or may comprise an input/output operation.

The term “non-programmable function” as generally used herein is a broad term and is to be given its ordinary and customary meaning to a person of ordinary skill in the art and is not to be limited to a special or customized meaning. In contrast to a programmable function, a non-programmable function may be an invariable or non-modifiable function or task. The non-programmable function may be a hardware function, specifically a non-programmable hardware function. Thus, opposite to the case of a programmable hardware function described above, the hardware function may not be programmable here. The non-programmable function may be implemented without using software or a programmable hardware element. The non-programmable function may be implemented by using one or more programmable hardware elements only. Thus, summarizing, a programmable function may be a software function or a hardware function, whereas a non-programmable function may be a hardware function only.

The programmable hardware element comprises at least one standby entity. The standby entity is configured for providing at least one programmable function for replacing the non-programmable functions of at least two non-programmable hardware elements. Thus, the standby entity may be configured for replacing at least two-programmable hardware elements. Ideally, the standby entity may be configured for providing a programmable function for replacing a non-programmable function of an arbitrary non-programmable hardware element of the electronic device. In other words, the standby entity may be configured for providing a programmable function for replacing a non-programmable function of any non-programmable hardware element of the electronic device. As an example, a non-programmable hardware element may fail during operation. Then, the standby entity, which may be in a standby mode before, may be activated and may replace the failed non-programmable hardware element within the electronic device. Such a replacement may comprise replacing a non-programmable hardware function by a software function or by a programmable hardware function.

The term “standby entity” as generally used herein is a broad term and is to be given its ordinary and customary meaning to a person of ordinary skill in the art and is not to be limited to a special or customized meaning. The standby entity may be an entity related to the programmable hardware element, which, in normal operation, may be in a standby mode or passive mode. The standby entity may be an entity related to the programmable hardware element, which, in fault operation, may be configured for being activated. Thus, the standby entity may be configured for being in an active mode in fault operation. A fault operation may generally be or may comprise a failure of a component of the electronic device, specifically of a non-programmable hardware device. A normal operation may generally be or may comprise a fault free operation of the electronic device, specifically an operation without a failure of a non-programmable hardware device. The standby entity may be at least one of a hardware element and a software element. As an example, the standby entity may be a hardware element, specifically programmable hardware element, executing a software element. The standby entity may be configured for providing a redundancy for at least two non-programmable hardware elements. Specifically, the standby entity may be configured for providing a redundancy for an arbitrary non-programmable hardware element of the electronic device. Thus, if one non-programmable hardware element fails, specifically if any one of the non-programmable hardware elements fails, the standby entity may be activated and may replace the failed non-programmable hardware element. This may ensure an at least restricted, ideally unrestricted continued operation of the electronic device.

The standby entity may be or may comprise a hardware element comprised by the programmable hardware element and/or a software element executed by the programmable hardware element or at least installed on the programmable hardware element. The standby entity may be or may comprise at least a part of the programmable hardware element. The standby entity may be selected from the group consisting of: a central processing unit (CPU) or at least a part thereof; a field programmable gate array (FPGA) or at least a part thereof; a graphic processing unit (GPU) or at least a part thereof; a programmable state machine or at least a part thereof; a software element, specifically a software program. Other options may be feasible. The standby entity may be a standby part, specifically a standby part of the programmable hardware element. The standby entity may comprise at least one hardware element, e.g. a processor or a part thereof. Additionally or alternatively, the standby entity may comprise at least one software element, e.g. a software program. Thus, the standby entity may be configured for providing at least one of a hardware function and a software function, specifically for replacing a failed hardware function. More specifically, the standby entity may be configured for providing at least one of a programmable hardware function and a software function, specifically for replacing a failed non-programmable hardware function.

As an example, for providing a software function, the standby entity may comprise at least one of a CPU configured for being software programmed and a software program configured for being executed in the CPU. Thus, in fault operation, the CPU may be software programmed for taking over a hardware function of a failed non-programmable hardware element. As a further example, for providing a hardware function, the standby entity may comprise an FPGA configured for being hardware programmed. Thus, in fault operation, the FPGA may be hardware programmed for taking over a hardware function of a failed non-programmable hardware element. Thus, generally, the standby entity may be at least one of software programmable and hardware programmable. More generally, the standby entity may be programmable, specifically re-programmable.

However, a previous programming of the programmable hardware element may not necessarily be required, before the programmable hardware element may be capable of taking over a hardware function of a failed non-programmable hardware element. Also without a previous programming, the programmable hardware element may already be in a configuration enabling it for taking over the hardware function of a failed non-programmable hardware element. As an example, a CPU may also directly take over the hardware function of a failed hardware accelerator. As a reminder, a hardware accelerator may typically be used for relieving the CPU. Thus, the CPU may already be capable of performing the hardware function of the hardware accelerator. However, the hardware accelerator may be specialized on that specific hardware accelerator, wherein the CPU may be more of a generalist. However, by being programmable, flexibility may be gained in a sense that different failed non-programmable hardware elements providing different hardware functions may be replaceable by using the standby entity.

The standby entity may be a standby element, specifically a unified standby element. The term “unified standby element” as generally used herein is a broad term and is to be given its ordinary and customary meaning to a person of ordinary skill in the art and is not to be limited to a special or customized meaning. The unified standby element may be an element, such as a hardware element or a software element, which, in normal operation, may be in a standby mode and which, in fault operation, may be in an active mode, specifically for replacing a failed element, more specifically for replacing a failed non-programmable hardware element. Ideally, the unified standby entity may be configured for providing at least one programmable function for replacing the non-programmable functions of an arbitrary non-programmable hardware element. In other words, the unified standby element may be configured for replacing an arbitrary non-programmable hardware element. In other words, the unified standby element may be configured for replacing any non-programmable hardware element of the electronic device. However, the unified standby element may also only be configured for replacing a selection of the non-programmable hardware elements of the electronic device. Specifically, the unified standby element may be configured for replacing at least two non-programmable hardware elements of the electronic device. Importantly, the unified standby element may be configured for replacing more than only one non-programmable hardware element of the electronic device, which may also be accomplished by a simple duplication of the non-programmable hardware element. However, as indicated, the unified standby element being comprised by the programmable hardware element may be programmable and may thus be capable of modifying its function giving further flexibility.

As already indicated, the programmable hardware element may comprise at least one processor. The processor may comprise the standby entity. Specifically, the standby entity may comprise at least one software element, specifically a software program, configured for replacing a non-programmable function of a non-programmable hardware element, specifically of a failed non-programmable hardware element in fault operation. Thus, the standby entity may comprise a standby software element, such as a software program which may not be executed in normal operation, but which may be executed in fault operation, specifically as a replacement for a non-programmable function, more specifically as a replacement for a non-programmable hardware function. The standby software element may be installed on the processor or more generally on the programmable hardware element. Additionally or alternatively, the standby software element may be installed on a further element, such as on an external memory. In such case, the standby software element may first be retrieved from the external memory and installed on the programmable hardware element before being executed.

Further, as already outlined, the standby entity may comprise a portion of the programmable hardware element, in which portion the software element may be executed. Further, the programmable hardware element may comprise at least two processors. The standby entity may comprise at least one processor. As an example, the programmable hardware element may comprise two processors and the standby entity may be one of them. Thus, the standby entity, or more specifically the standby element, may be a dedicated processor, which, in normal operation, may be in a standby mode and which, in fault operation, may be in an active mode for replacing a failed non-programmable hardware element. Thus, the programmable hardware element may comprise at least one processor separate from the standby element, specifically a main processor, e.g. a main CPU. The processor, specifically the main processor, may be configured for controlling operation of the electronic device, specifically of the non-programmable hardware elements, in normal operation. In case of a failure event, as indicated, the standby element may then replace a failed non-programmable hardware element. Additionally or alternatively, the electronic device may comprise at least two programmable hardware elements. One of the at least two programmable hardware elements may be the standby entity, specifically the standby element.

The electronic device further comprises at least one arbiter. The term “arbiter” as generally used herein is a broad term and is to be given its ordinary and customary meaning to a person of ordinary skill in the art and is not to be limited to a special or customized meaning. The arbiter may be a device configured for allocating access to components within a system. Specifically, the arbiter may be configured for allocating access to at least one of a programmable hardware element and a non-programmable hardware element within the electronic device. Thus, the arbiter may be configured for activating and/or deactivating components. Specifically, the arbiter may be configured for activating and/or deactivating at least one of a non-programmable hardware element and a programmable hardware element or at least a part thereof, such as the standby entity. The arbiter may be an analog device. As an example, the arbiter may be an analog circuit configured for turning on and/or turning off or for connecting and/or disconnecting components. The arbiter may be a digital device. Specifically, the arbiter may at least partially be comprised by the programmable hardware element, specifically by the standby entity. Thus, as an example, the arbiter may be part of a CPU or may be implemented within the CPU.

As an example, the arbiter may be configured for initiating execution of a software element, specifically of a software program. The arbiter may be configured for initiating installation of a software element, specifically of a software program. Thus, the arbiter may be configured for activating a programming of the standby entity with the programmable function. As already indicated, the programmable function may then replace a failed non-programmable function. The arbiter may comprise a software element, specifically a software program. Further, the arbiter may be configured for receiving at least one element of information on a component of a system comprising the arbiter. Specifically, the arbiter may be configured for receiving at least one element of information on a failure of a non-programmable hardware element by using at least one of start-up diagnostics and on-the-fly diagnostics.

The arbiter is configured for deactivating at least one non-programmable hardware element. Specifically, the arbiter may be configured for deactivating any one of the non-programmable hardware elements. The arbiter is configured for activating the standby entity for replacing at least one non-programmable function provided by the non-programmable hardware element with at least one programmable function. Thus, by activating the standby entity, a non-programmable function provided by the non-programmable hardware element may be replaced with a programmable function provided by the standby entity. The term “activating”, or any grammatical variation thereof, as generally used herein is a broad term and is to be given its ordinary and customary meaning to a person of ordinary skill in the art and is not to be limited to a special or customized meaning. The term “activating” may refer to a process of starting, turning on, switching on, initializing or launching something. Activating the standby entity may comprise turning on the standby entity and/or connecting the standby entity within the electronic device. As an example, the standby entity may comprise an FPGA and the FPGA may be turned on by the arbiter for replacing a failed non-programmable hardware component. Activating the standby entity may comprise starting the standby entity. As an example, the standby entity may comprise at least one software program and activating the standby entity may comprise executing the software program or installing the software program and then executing the software program. The term “deactivating”, or any grammatical variation thereof, as generally used herein is a broad term and is to be given its ordinary and customary meaning to a person of ordinary skill in the art and is not to be limited to a special or customized meaning. The term “deactivating” may refer to a process of stopping, turning off, switching off something. Thus, as an example, deactivating a non-programmable hardware element may comprise turning off the non-programmable hardware element and/or disconnecting the non-programmable hardware element.

The term “replacing”, or any grammatical variation thereof, as generally used herein is a broad term and is to be given its ordinary and customary meaning to a person of ordinary skill in the art and is not to be limited to a special or customized meaning. The term “replacing” may refer to a process of substituting, exchanging or compensating. The replacing may comprise a fully replacing or a partially replacing. The replacing may be a replacing of a first entity by a second entity, wherein the first entity and the second entity may be of identical type or specifically also of different type. Specifically, a failed non-programmable hardware function may be replaced by a programmable hardware function or by a software function. The software function may fully replace the failed non-programmable hardware function. However, the software function may also only partially replace the failed non-programmable hardware function. As an example, a failed hardware accelerator specialized on a specific task may be replaced by using a CPU which may not be specialized on the specific task and which may thus perform it less efficiently.

The arbiter may be configured for activating the standby entity only in case of a critical failure. Thus, the arbiter may be configured for not activating the standby entity in case of a non-critical failure, e.g. a failure which may not severely compromise the electronic device or a failure in which the electronic device remains at least for the most part operational. The term “critical failure” as generally used herein is a broad term and is to be given its ordinary and customary meaning to a person of ordinary skill in the art and is not to be limited to a special or customized meaning. A critical failure may be a failure of a component which may severely compromise an entire system comprising the component or which may even result in a complete failure of the system. Specifically, a critical failure may be a failure of a non-programmable hardware element which may result in a complete failure of the electronic device or which may at least severely compromise the electronic device. The critical failure may be selected from the group consisting of: a safety related failure; a failure of a high availability non-programmable hardware element. Specifically, the critical failure may be a safety related failure of a high availability non-programmable hardware element. A safety related failure may specifically, as for instance in an automotive application, relate to a personal safety of humans, such as car passengers.

The electronic device may further comprise at least one internal memory. The standby entity may be configured for receiving the programmable function for replacing the non-programmable function from the internal memory. The internal memory may be a memory within the electronic device. Generally, a memory may be a device configured for storing at least one element of information, such as data and/or instructions. Additionally or alternatively, the electronic device may comprise at least one external memory interface. The standby entity may be configured for receiving the programmable function for replacing the non-programmable function from at least one external memory via the external memory interface. The external memory may be a memory outside of the electronic device. The external memory may be connected to the electronic device, such as by using a wired or a wireless connection. Additionally or alternatively, the electronic device may comprise at least one general purpose input/output (GPIO). The standby entity may be configured for receiving the programmable function for replacing the non-programmable function from at least one external memory via the GPIO. Additionally or alternatively, the electronic device may comprise at least one low voltage differential signaling (LVDS). The standby entity may be configured for receiving the programmable function for replacing the non-programmable function from at least one external memory via the LVDS. Additionally or alternatively, the electronic device may comprise at least one Serializer/Deserializer (SerDes). The standby entity may be configured for receiving the programmable function for replacing the non-programmable function from at least one external memory via the SerDes.

In a further aspect, an embedded system is presented. The term “system” as generally used herein is a broad term and is to be given its ordinary and customary meaning to a person of ordinary skill in the art and is not to be limited to a special or customized meaning. A system may be an arbitrary set of interacting or interdependent components or parts forming a whole. Specifically, the components may interact with each other in order to fulfill at least one common function. The at least two components may be handled independently or may be coupled or connectable. The term “embedded system” as generally used herein is a broad term and is to be given its ordinary and customary meaning to a person of ordinary skill in the art and is not to be limited to a special or customized meaning. An embedded system may be a system, specifically a processing system or a computer system, configured for performing a specific function or task, e.g. within a superordinate system configured for performing a plurality of functions. In contrast, general purpose computers may be configured for performing a wide variety of different functions. Software being performed within an embedded system may typically be tailored to the hardware used in the embedded system.

The embedded system comprises at least one electronic device. The electronic device comprises a plurality of non-programmable hardware elements. Each non-programmable hardware element is configured for providing at least one non-programmable function. The electronic device further comprises at least one programmable hardware element. The programmable hardware element is configured for providing at least one programmable function. The programmable hardware element comprises at least one standby entity. The standby entity is configured for providing at least one programmable function for replacing the non-programmable functions of at least two non-programmable hardware elements. The electronic device further comprises at least one arbiter. The arbiter is configured for deactivating at least one non-programmable hardware element. The arbiter is further configured for activating the standby entity for replacing at least one non-programmable function provided by the non-programmable hardware element with at least one programmable function. Specifically, the electronic device may be an electronic device according to any one of embodiments described above or below in further detail referring to an electronic device.

The embedded system further comprises at least one further device controlled by the electronic device. The further device may be selected from the group consisting of: a sensor; an actuator. Other options may be feasible. The term “controlling”, or any grammatical variation thereof, as generally used herein is a broad term and is to be given its ordinary and customary meaning to a person of ordinary skill in the art and is not to be limited to a special or customized meaning. The controlling may be a process of regulating or monitoring or supervising or operating or directing or driving. As an example, the controlling may comprise monitoring a sensor and/or processing sensor data. As a further example, the controlling may comprise operating an actuator. The further device may be controlled by the electronic device by using at least one of a hardware function and a software function. In normal operation, the further device may be controlled by using at least one non-programmable function provided by at least one non-programmable hardware element of the plurality of non-programmable hardware elements of the electronic device. The non-programmable function may specifically be a non-programmable hardware function. In fault operation, the further device may be controlled by using at least one programmable function provided by the standby entity. The programmable function may specifically be a programmable hardware function or a software function. For further definitions and embodiments regarding the presented embedded system, reference may be made to the definitions and embodiments presented with respect to the electronic device.

In a further aspect, a method for operating at least one electronic device is presented. The electronic device may be an electronic device according to any one of the embodiments described above or below in further detail referring to an electronic device. The method comprises the following acts, which are performed by using an arbiter of the electronic device: deactivating a non-programmable hardware element of the electronic device; and activating a standby entity of a programmable hardware element of the electronic device for replacing at least one non-programmable function provided by the non-programmable hardware element with at least one programmable function provided by the standby entity. Further elements may also be involved.

The method acts may be performed in the given order. It shall be noted, however, that a different order may also be possible. The method may comprise further method acts which are not listed. Further, one or more of the method acts may be performed once or repeatedly. Further, two or more of the method acts may be performed simultaneously or in a timely overlapping fashion.

The method may further comprise act a1). Act a1) may be performed before act a). Act a1) may comprise receiving at least one element of information on a failure of the non-programmable hardware element by using the arbiter. Act a1) may further comprise using at least one of start-up diagnostics and on-the-fly diagnostics. Thus, act a1) may overall comprise receiving at least one element of information on a failure of the non-programmable hardware element by using the arbiter and at least one of start-up diagnostics and on-the-fly diagnostics. The method may further comprise act a2). Act a2) may be performed before act a). Act a2) may comprise defining at least one critical failure. At least one of acts a) and b) may be performed only in case of the critical failure. The critical failure may be selected from the group consisting of: a safety related failure; a failure of a high availability non-programmable hardware element. Specifically, the critical failure may be a safety related failure of a high availability non-programmable hardware element. The arbiter may at least partially be comprised by the programmable hardware element, specifically by the standby entity. At least one of acts a) and b) may be performed by using the programmable hardware element, specifically by using the standby entity.

The method may further comprise act b1). Act b1) may be performed before act b). Act b1) may comprise programming the standby entity with a programmable function for replacing the non-programmable function provided by the non-programmable hardware element. The programming may comprise at least one of software programming and hardware programming. The programming may comprise receiving a least one software program from at least one memory, such as an internal memory or an external memory. The programming may comprise installing the software program, specifically on the programmable hardware element. The electronic device may comprise at least one internal memory. The method may further comprise act b2). Act b2) may be performed before act b). Act b2) may comprise receiving the programmable function for replacing the non-programmable function from the internal memory. The electronic device may comprise at least one external memory interface. The method may further comprise act b3). Act b3) may be performed before act b). Act b3) may comprise receiving the programmable function for replacing the non-programmable function from an external memory via the external memory interface. The electronic device may comprise at least one GPIO. The method may further comprise act b4). Act b4) may be performed before act b). Act b4) may comprise receiving the programmable function for replacing the non-programmable function from an external memory via the GPIO. The electronic device may comprise at least one LVDS. The method may further comprise act b5). Act b5) may be performed before act b). Act b5) may comprise receiving the programmable function for replacing the non-programmable function from an external memory via the LVDS. The electronic device may comprise at least one SerDes. The method may further comprise act b6). Act b6) may be performed before act b). Act b6) may comprise receiving the programmable function for replacing the non-programmable function from an external memory via the SerDes.

The method may at least partially be computer-implemented. The term “computer-implemented” as generally used herein is a broad term and is to be given its ordinary and customary meaning to a person of ordinary skill in the art and is not to be limited to a special or customized meaning. The term “computer-implemented” may refer to a method involving at least one computer or processor. The computer or processor may comprise at least one data processing device which may be configured for performing at least one of the method acts according to the present disclosure. The method acts may at least partially be performed automatically, specifically without user interaction. For further definitions and embodiments regarding the presented method, reference may be made to the definitions and embodiments presented with respect to the electronic device.

In a further aspect, a use of an electronic device according to any one of the embodiments described above or below in further detail referring to an electronic device or of a method for operating at least one electronic device according to any one of the embodiments described above or below in further detail referring to a method is presented for a purpose of use selected from the group consisting of: an automotive application; a medical application, specifically an implant; a remote-controlled application; an industry application.

The devices and methods presented herein have considerable advantages over the prior art as already indicated throughout the description. They may specifically reduce implementation costs for providing tolerances for hardware failures. Specifically, a duplication of several components may be avoided. The presented standby entity may provide a redundancy for a variety of components. Thus, specifically in highly integrated systems, such as in a SoC, there may be more area available for further components providing further functions within the system. Further, production costs may be decreased, efforts for testing the device or system may be reduced and power consumption may also be minimized. The presented standby entity, which may take over various functions if required, may provide great flexibility in the design of a system, such as in deciding which functions shall be taken over.

As used herein, the terms “have”, “comprise” or “include” or any arbitrary grammatical variations thereof are used in a non-exclusive way. Thus, these terms may both refer to a situation in which, besides the feature introduced by these terms, no further features are pre-sent in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The disclosure may be performed by using alternative features. Similarly, features introduced by “in an embodiment of the disclosure” or similar expressions are intended to be optional features, without any restriction regarding alternative embodiments of the disclosure, without any restrictions regarding the scope of the disclosure and without any restriction regarding the possibility of combining the features introduced in such way with other optional or non-optional features of the disclosure.

Summarizing and without excluding further possible embodiments, the following embodiments may be envisaged:

Embodiment 1: An electronic device comprising: a plurality of non-programmable hardware elements, each non-programmable hardware element being configured for providing at least one non-programmable function; at least one programmable hardware element configured for providing at least one programmable function, wherein the programmable hardware element comprises at least one standby entity, wherein the standby entity is configured for providing at least one programmable function for replacing the non-programmable functions of at least two non-programmable hardware elements; and at least one arbiter configured for deactivating at least one non-programmable hardware element and for activating the standby entity for replacing at least one non-programmable function provided by the non-programmable hardware element with at least one programmable function.

Embodiment 2: The electronic device according to the preceding Embodiment, wherein the electronic device comprises at least one semiconductor device.

Embodiment 3: The electronic device according to any one of the preceding Embodiments, wherein the electronic device is a microcontroller.

Embodiment 4: The electronic device according to any one of the preceding Embodiments, wherein the non-programmable hardware elements are configured for providing at least partially diverse non-programmable functions.

Embodiment 5: The electronic device according to any one of the preceding Embodiments, wherein the programmable function is at least one of a software function and a hardware function.

Embodiment 6: The electronic device according to any one of the preceding Embodiments, wherein the non-programmable function is a hardware function.

Embodiment 7: The electronic device according to any one of the preceding Embodiments, wherein the standby entity is programmable, specifically re-programmable.

Embodiment 8: The electronic device according to any one of the preceding Embodiments, wherein the standby entity is at least one of software programmable and hardware programmable.

Embodiment 9: The electronic device according to any one of the preceding Embodiments, wherein the standby entity comprises at least a part of the programmable hardware element.

Embodiment 10: The electronic device according to any one of the preceding Embodiments, wherein the standby entity is a standby element, specifically a unified standby element.

Embodiment 11: The electronic device according to the preceding Embodiment, wherein the programmable hardware element comprises at least one processor separate from the standby element, specifically a main processor.

Embodiment 12: The electronic device according to any one of the preceding Embodiments, wherein the programmable hardware element comprises at least one processor, wherein the processor comprises the standby entity.

Embodiment 13: The electronic device according to any one of the preceding Embodiments, wherein the programmable hardware element comprises at least two processors, wherein the standby entity comprises at least one processor.

Embodiment 14: The electronic device according to any one of the preceding Embodiments, wherein the programmable hardware element comprises at least one element selected from the group consisting of: a central processing unit (CPU); a field programmable gate array (FPGA); a graphic processing unit (GPU); a programmable state machine.

Embodiment 15: The electronic device according to any one of the preceding Embodiments, wherein the standby entity is selected from the group consisting of: a central processing unit (CPU) or at least a part thereof; a field programmable gate array (FPGA) or at least a part thereof; a graphic processing unit (GPU) or at least a part thereof; a programmable state machine or at least a part thereof; a software element, specifically a software program.

Embodiment 16: The electronic device according to any one of the preceding Embodiments, wherein the non-programmable hardware elements are selected from the group consisting of: a hardware accelerator; an input/output interface (IO interface).

Embodiment 17: The electronic device according to any one of the preceding Embodiments, wherein the non-programmable hardware elements are selected from the group consisting of: a serial peripheral interface (SPI); a universal asynchronous receiver transmitter (UART); a digital signal processor (DSP); a universal serial bus (USB); an inter-integrated circuit (I²C); a direct memory access (DMA).

Embodiment 18: The electronic device according to any one of the preceding Embodiments, wherein the arbiter is configured for activating a programming of the standby entity with the programmable function.

Embodiment 19: The electronic device according to any one of the preceding Embodiments, wherein the arbiter is configured for activating the standby entity only in case of a critical failure.

Embodiment 20: The electronic device according to the preceding Embodiment, wherein the critical failure is selected from the group consisting of: a safety related failure; a failure of a high availability non-programmable hardware element.

Embodiment 21: The electronic device according to any one of the preceding Embodiments, wherein the arbiter is at least partially comprised by the programmable hardware element, specifically by the standby entity.

Embodiment 22: The electronic device according to any one of the preceding Embodiments, wherein the arbiter is configured for receiving at least one element of information on a failure of the non-programmable hardware element by using at least one of start-up diagnostics and on-the-fly diagnostics.

Embodiment 23: The electronic device according to any one of the preceding Embodiments, further comprising at least one internal memory, wherein the standby entity is configured for receiving the programmable function for replacing the non-programmable function from the internal memory.

Embodiment 24: The electronic device according to any one of the preceding Embodiments, further comprising at least one external memory interface, wherein the standby entity is configured for receiving the programmable function for replacing the non-programmable function from at least one external memory via the external memory interface.

Embodiment 25: The electronic device according to any one of the preceding Embodiments, further comprising at least one general purpose input/output (GPIO), wherein the standby entity is configured for receiving the programmable function for replacing the non-programmable function from at least one external memory via the GPIO.

Embodiment 26: The electronic device according to any one of the preceding Embodiments, further comprising at least one low voltage differential signaling (LVDS), wherein the standby entity is configured for receiving the programmable function for replacing the non-programmable function from at least one external memory via the LVDS.

Embodiment 27: The electronic device according to any one of the preceding Embodiments, further comprising at least one Serializer/Deserializer (SerDes), wherein the standby entity is configured for receiving the programmable function for replacing the non-programmable function from at least one external memory via the SerDes.

Embodiment 28: The electronic device according to any one of the preceding Embodiments, further comprising at least one interconnect configured for at least partially interconnecting electronic components of the electronic device.

Embodiment 29: The electronic device according to any one of the preceding Embodiments, wherein the electronic device comprises at least one of a system on a chip (SoC) and a system in a package (SiP).

Embodiment 30: An embedded system comprising at least one electronic device, the electronic device comprising: a plurality of non-programmable hardware elements, each non-programmable hardware element being configured for providing at least one non-programmable function; at least one programmable hardware element configured for providing at least one programmable function, wherein the programmable hardware element comprises at least one standby entity, wherein the standby entity is configured for providing at least one programmable function for replacing the non-programmable functions of at least two non-programmable hardware elements; and at least one arbiter configured for deactivating at least one non-programmable hardware element and for activating the standby entity for replacing the non-programmable function provided by the non-programmable hardware element with at least one programmable function; wherein the embedded system further comprises: at least one further device controlled by the electronic device.

Embodiment 31: The embedded system according to the preceding Embodiment, wherein the electronic device is an electronic device according to any one of the preceding Embodiments referring to an electronic device.

Embodiment 32: The embedded system according to any one of the preceding Embodiments referring to an embedded system, wherein the further device is selected from the group consisting of: a sensor; an actuator.

Embodiment 33: The embedded system according to any one of the preceding Embodiments referring to an embedded system, wherein the further device is controlled by the electronic device by using at least one of a hardware function and a software function.

Embodiment 34: The embedded system according to any one of the preceding Embodiments referring to an embedded system, wherein, in normal operation, the further device is controlled by using at least one non-programmable function provided by at least one non-programmable hardware element of the plurality of non-programmable hardware elements of the electronic device, wherein, in fault operation, the further device is controlled by using at least one programmable function provided by the standby entity.

Embodiment 35: A method for operating at least one electronic device, the method comprising the following acts performed by using an arbiter of the electronic device: deactivating a non-programmable hardware element of the electronic device; and activating a standby entity of a programmable hardware element of the electronic device for replacing at least one non-programmable function provided by the non-programmable hardware element with at least one programmable function provided by the standby entity.

Embodiment 36: The method according to the preceding Embodiment, wherein the electronic device is an electronic device according to any one of the preceding Embodiments referring to an electronic device.

Embodiment 37: The method according to any one of the preceding method Embodiments, further comprising act a1) performed before act a), wherein act a1) comprises receiving at least one element of information on a failure of the non-programmable hardware element by using the arbiter.

Embodiment 38: The method according to the preceding Embodiment, wherein act a1) comprises using at least one of start-up diagnostics and on-the-fly diagnostics.

Embodiment 39: The method according to any one of the preceding method Embodiments, further comprising act a2) performed before act a), wherein act a2) comprises defining at least one critical failure.

Embodiment 40: The method according to the preceding method Embodiment, wherein at least one of acts a) and b) is performed only in case of the critical failure.

Embodiment 41: The method according to any one of the two preceding Embodiments, wherein the critical failure is selected from the group consisting of: a safety related failure; a failure of a high availability non-programmable hardware element.

Embodiment 42: The method according to any one of the preceding method Embodiments, wherein the arbiter is at least partially comprised by the programmable hardware element, specifically by the standby entity, wherein at least one of acts a) and b) is performed by using the programmable hardware element, specifically by using the standby entity.

Embodiment 43: The method according to any one of the preceding method Embodiments, further comprising act b1) performed before act b), wherein act b1) comprises programming the standby entity with a programmable function for replacing the non-programmable function provided by the non-programmable hardware element.

Embodiment 44: The method according to the preceding Embodiment, wherein the programming comprises at least one of software programming and hardware programming.

Embodiment 45: The method according to any one of the preceding method Embodiments, further comprising act b2) performed before act b), wherein the electronic device comprises at least one internal memory, wherein act b2) comprises receiving the programmable function for replacing the non-programmable function from the internal memory.

Embodiment 46: The method according to any one of the preceding method Embodiments, further comprising act b3) performed before act b), wherein the electronic device comprises at least one external memory interface, wherein act b3) comprises receiving the programmable function for replacing the non-programmable function from an external memory via the external memory interface.

Embodiment 47: The method according to any one of the preceding method Embodiments, further comprising act b4) performed before act b), wherein the electronic device comprises at least one GPIO, wherein act b4) comprises receiving the programmable function for replacing the non-programmable function from an external memory via the GPIO.

Embodiment 48: The method according to any one of the preceding method Embodiments, further comprising act b5) performed before act b), wherein the electronic device comprises at least one LVDS, wherein act b5) comprises receiving the programmable function for replacing the non-programmable function from an external memory via the LVDS.

Embodiment 49: The method according to any one of the preceding method Embodiments, further comprising act b6) performed before act b), wherein the electronic device comprises at least one SerDes, wherein act b6) comprises receiving the programmable function for replacing the non-programmable function from an external memory via the SerDes.

Embodiment 50: The method according to any one of the preceding method Embodiments, wherein the method is at least partially computer-implemented.

Embodiment 51: A use of an electronic device according to any one of the preceding Embodiments referring to an electronic device or a method for operating at least one electronic device according to any one of the preceding method Embodiments for a purpose of use selected from the group consisting of: an automotive application; a medical application, specifically an implant; a remote-controlled application; an industry application.

Further optional features and embodiments will be disclosed in more detail in the subsequent description of embodiments, preferably in conjunction with the dependent embodiments. Therein, the respective optional features may be realized in an isolated fashion as well as in any arbitrary feasible combination. The scope of the disclosure is not restricted by the preferred embodiments. The embodiments are schematically depicted in the Figures. Therein, identical reference numbers in these Figures refer to identical or functionally comparable elements.

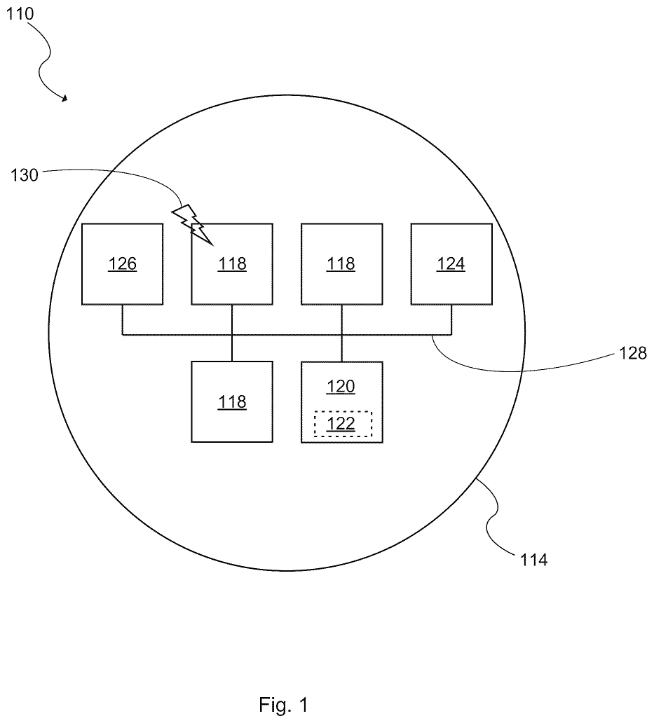

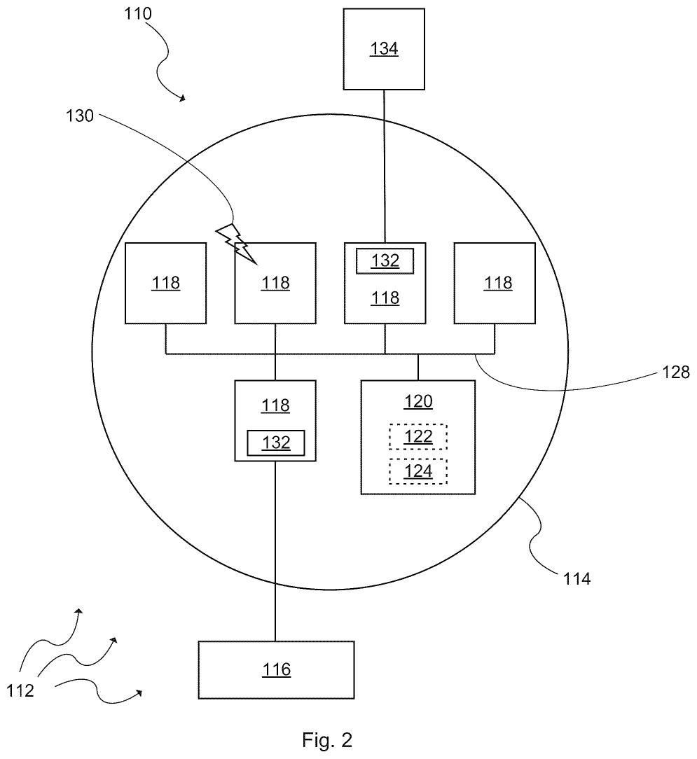

FIG. 1 illustrates an exemplary embodiment of an electronic device 110 according to the present disclosure in a highly schematic fashion. Further, FIG. 2 illustrates an exemplary embodiment of an embedded system 112 according to the present disclosure in a highly schematic fashion. The embedded system 112 comprises a further exemplary embodiment of the electronic device 110. However, the embedded system 112 is not restricted to the specific embodiment of the electronic device 110 shown in FIG. 2. Specifically, the embedded system 112 may comprise any embodiment of the electronic device 110 described above or below in further detail. Further, instead of the embodiment of the electronic device 110 shown in FIG. 1, a variety of further embodiments is also feasible as presented throughout the disclosure. Thus, FIG. 1 and FIG. 2 only show exemplary embodiments out of a variety of different conceivable embodiments of the electronic device 110 and the embedded system 112 for illustration and shall not be construed to unduly limit the scope of the present disclosure. In the following, FIG. 1 and FIG. 2 will at least partially be described in conjunction.

As said, FIG. 1 illustrates an exemplary embodiment of the electronic device 110. The electronic device 110 may be a semiconductor device. Thus, the electronic device 110 may be arranged on a substrate 114, wherein the substrate 114 may comprise at least one semiconductor material, specifically at least one of silicon, silicon carbide and gallium nitride. Thus, the substrate 114 may be a wafer or specifically a part thereof. Thus, the electronic circuit 110 may specifically be an integrated circuit. The electronic device 110 may be a system on a chip. Further, the electronic device 110 may be a system in a package. The electronic device 110 may further be a microcontroller. Thus, as indicated in FIG. 2, the electronic device 110 may specifically be configured for controlling at least one further device 116, such as a sensor or an actuator.

The electronic device 110 comprises a plurality of non-programmable hardware elements 118, such as two non-programmable hardware elements 118 or three non-programmable hardware elements 118 as shown in FIG. 1 or even more. Each non-programmable hardware element 118 is configured for providing at least one non-programmable function. The non-programmable function may specifically be a hardware function. Specifically, the non-programmable hardware elements 118 may be configured for providing at least partially diverse or different non-programmable functions. The electronic device 110 further comprises at least one programmable hardware element 120. The programmable hardware element 120 is configured for providing at least one programmable function. The programmable function may specifically be at least one of a software function and a hardware function. The programmable hardware element 120 comprises at least one standby entity 122. The standby entity 122 is configured for providing at least one programmable function for replacing the non-programmable functions of at least two non-programmable hardware elements 118. As an example, the standby entity 122 may be configured for providing a programmable function for replacing two of the three non-programmable hardware elements 118 shown in FIG. 1.

The electronic device comprises at least one arbiter 124. The arbiter 124 is configured for deactivating at least one non-programmable hardware element 118. The arbiter 124 is further configured for activating the standby entity 122 for replacing at least one non-programmable function provided by the non-programmable hardware element 118 with at least one programmable function. Thus, the arbiter 124 may be configured for activating a programming of the standby entity 122 with the programmable function, specifically for replacing a failed non-programmable function. The electronic device 110 may further comprise an internal memory 126. The standby entity 122 may be configured for receiving the programmable function for replacing the non-programmable function from the internal memory 126. The electronic device 110 may further comprise an interconnect 128. The interconnect 128 may be configured for at least partially interconnecting the non-programmable hardware elements 118, the programmable hardware element 120, the standby entity 122, the arbiter 124 and the internal memory 126 of the electronic device 110 as shown in FIG. 1.

As an example, in normal operation, all non-programmable hardware elements 118 may operate error free. However, during operation one of the non-programmable hardware elements 118 may fail, as indicated by using lightning symbol 130. Thus, the electronic device 110 may be forced into fault operation. Instead of initially duplicating the failed non-programmable hardware element 118 for replacing it with its twin in fault operation, the standby entity 122 may now be used. First, the arbiter 124 may be informed about the failed non-programmable hardware element 118. Thereupon, the arbiter 124 may deactivate the failed non-programmable hardware element 118 and activate the standby entity 122. The standby entity 122 may be programmable, specifically re-programmable. More specifically, the standby entity 122 may be at least one of software programmable and hardware programmable. Thus, the standby entity 122 may be programmed, such as by receiving a programmable function, e.g. a software program, from the internal memory 126. The programmable function may be configured for replacing the failed hardware function. Thus, the standby entity 122 may install and execute the programmable function, such that the failure of the non-programmable hardware element 118 can be compensated.

The above described example is only one example out of plurality of conceivable examples, which were described for illustrating a principle working scheme of the presented electronic device 110. Thus, the electronic device 110 may provide a user with great flexibility with respect to an exact configuration of the electronic device 110 within different applications. A twin of a non-programmable hardware element 118 may in contrast be very limited in its application. The standby entity 122 may however be capable of replacing a variety of different non-programmable hardware elements 118 in case of different failures. Thus, the standby entity 122 may specifically be a unified standby element. More generally, the standby entity 122 may be a standby element. The standby entity 122 may comprise at least a part of the programmable hardware element 120. Thus, the standby entity 122 may be a standby part of the programmable hardware element 120, e.g. a processor or a part thereof. However, the standby entity 122 may specifically also be or comprise non-physical software, such as software programs executed on a processor. Thus, the programmable hardware element 120 may comprise a processor and the processor may comprise the standby entity 122. However, the programmable hardware element 120 may also comprise two or more processors and the standby entity may be one of them. Thus, the programmable hardware element 120 may comprise at least one processor separate from the standby element.

Specifically, the processor may be at least one of a central processing unit (CPU); a field programmable gate array (FPGA); a graphic processing unit (GPU) and a programmable state machine. Thus, the programmable hardware element 120 may comprise at least one element selected from the group consisting of: a central processing unit (CPU); a field programmable gate array (FPGA); a graphic processing unit (GPU); a programmable state machine. Thus, the standby entity 122 may be selected from the group consisting of: a central processing unit (CPU) or at least a part thereof; a field programmable gate array (FPGA) or at least a part thereof; a graphic processing unit (GPU) or at least a part thereof; a programmable state machine or at least a part thereof; a software element, specifically a software program. On the other hand, the non-programmable hardware elements 118 may specifically be selected from the group consisting of: a hardware accelerator; an input/output interface (IO interface). As an example, one non-programmable hardware element 118 may be a hardware accelerator and another non-programmable hardware element 118 may be an IO interface. More specifically, the non-programmable hardware elements 118 may be selected from the group consisting of: a serial peripheral interface (SPI); a universal asynchronous receiver transmitter (UART); a digital signal processor (DSP); a universal serial bus (USB); an inter-integrated circuit (I²C); a direct memory access (DMA). Other options may be feasible.

As said, FIG. 2 illustrates an exemplary embodiment of an embedded system 112 according to the present disclosure in a highly schematic fashion. The embedded system 112 comprises another embodiment of the electronic device 110 compared to the one shown in FIG. 1. However, as outlined, in principle, the embedded system 112 may also comprise the electronic device 110 shown in FIG. 1 or also other embodiments of the electronic device 110. Thus, for describing the exemplary embodiment of the electronic device 110 shown in FIG. 2, reference may be made at least to a large extent to the description of FIG. 1. Specifically, the embedded system 112 comprises the further device 116 as shown in FIG. 2, which may for instance be a sensor or an actuator. The further device 116 is controlled by using the electronic device 110. Specifically, the further device 116 may be controlled by using at least one of a hardware function and a software function. In normal operation, the further device 116 may be controlled by using at least one non-programmable function provided by at least one non-programmable hardware element 118 of the plurality of non-programmable hardware elements 118 of the electronic device 110. In fault operation, the further device 116 may be controlled by using at least one programmable function provided by the standby entity 122. In other words, the failed non-programmable hardware element 118, again indicated by the lightning symbol 130 in FIG. 2, may be replaced by using the standby entity 122.

As already indicated and as shown in FIG. 2, at least one of the non-programmable hardware elements 118 may be an IO interface. Thus, at least one of the non-programmable hardware elements 118 may comprise at least one pin 132. At least one of the non-programmable hardware elements 118 may be connected to at least one element outside of the electronic device 110, specifically to the further device 116, or even to at least one element outside of the embedded system 112, such as an external memory 134. Other options may be also be feasible. Thus, at least one of the non-programmable hardware elements 118 may be or may comprise an external memory interface. The standby entity 122 may be configured for receiving the programmable function for replacing the non-programmable function of the failed non-programmable hardware element 118 via the external memory interface from the external memory 134. As an example, the external memory interface may be or may comprise at least one of a GPIO, a LVDS and a SerDes.

As further shown in FIG. 2, the arbiter 124 may at least partially be comprised by the programmable hardware element 120. The arbiter 124 may be at least one of hardware implemented and software implemented. The arbiter 124 may be configured for receiving at least one element of information on a failure of the non-programmable hardware element 118 by using at least one of start-up diagnostics and on-the-fly diagnostics. The arbiter 124 may further be configured for activating the standby entity 122 only in case of a critical failure. The critical failure may be selected from the group consisting of: a safety related failure; a failure of a high availability non-programmable hardware element 118. Specifically, the critical failure may be a safety related failure of a high availability non-programmable hardware element 118.

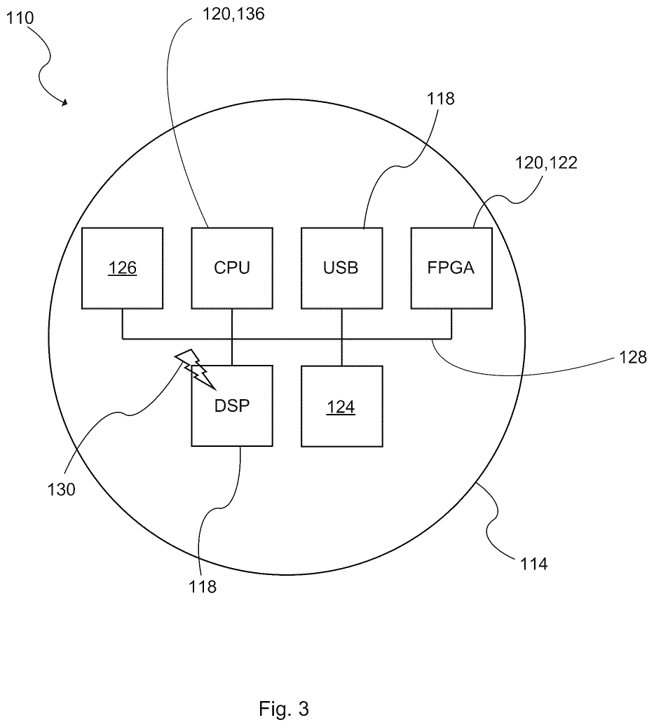

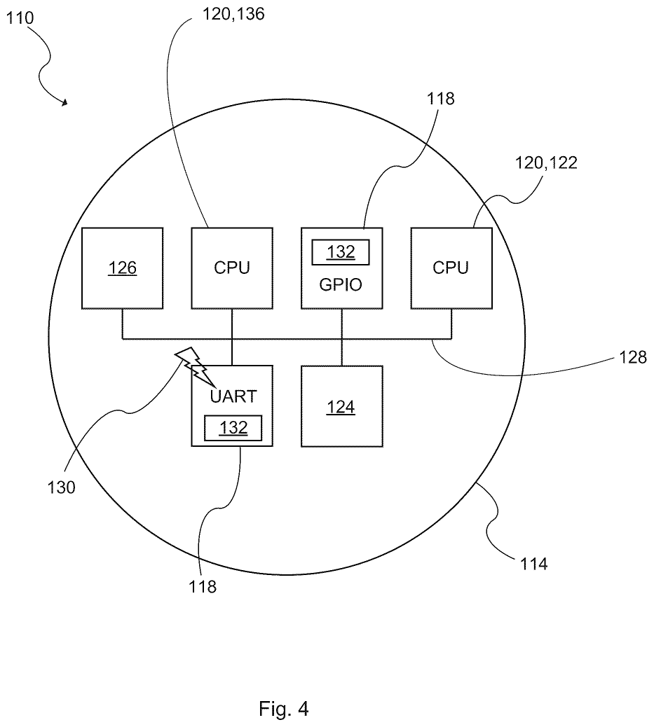

FIGS. 3 and 4 illustrate specific exemplary embodiments of the electronic device 110 in a highly schematic fashion. FIGS. 3 and 4 are only meant for further illustration and are not intended to be restrictive. As already indicated, the electronic device 110 may comprise a plurality of programmable hardware elements 120, specifically processors. As shown in FIG. 3, the electronic device 110 may comprise two programmable hardware elements 120, specifically a CPU and an FPGA. In FIG. 3, the FPGA acts as the standby entity 122 and the CPU acts as a main processor 136 of the electronic device 110. In case of a failure of the DSP, indicated by the lightning symbol 130, the FPGA may be enabled by the arbiter 124 and may replace the failed DSP. As shown FIG. 4, the electronic device 110 may comprise two CPUs as programmable hardware elements 120, wherein one acts as the standby entity 122 and the other one as the main processor 136. Here, a UART may fail, again indicated by the lightning symbol 130, and one CPU may replace it. As said, these are just examples for further illustration. Other options are of course feasible.

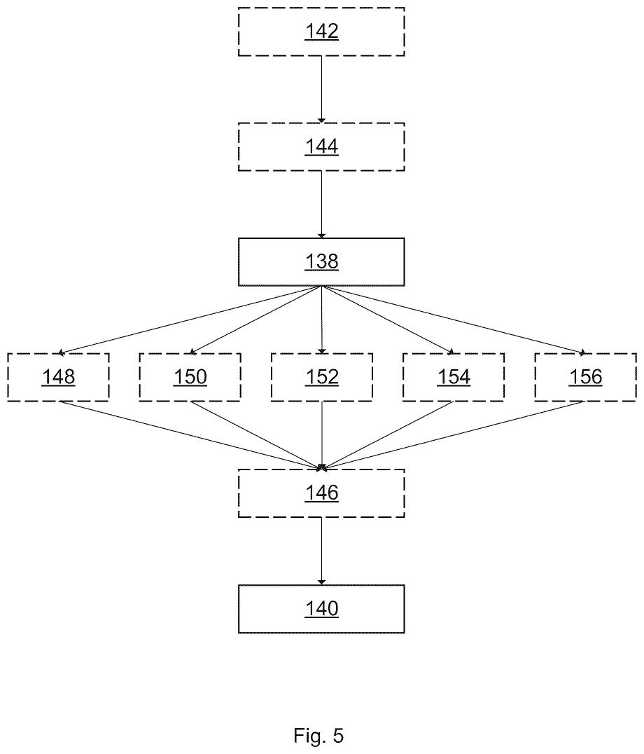

FIG. 5 illustrates a flow chart of an exemplary embodiment of a method for operating the electronic device 110. The method comprises the following acts. The acts are performed by using an arbiter of the electronic device. Further elements may also be involved.

Act 138 deactivates a non-programmable hardware element 118 of the electronic device 110; and

Act 140 activates a standby entity 122 of a programmable hardware element 120 of the electronic device 110 for replacing at least one non-programmable function provided by the non-programmable hardware element 118 with at least one programmable function provided by the standby entity 122.

The method acts may be performed in the given order. It shall be noted, however, that a different order may also be possible. The method may comprise further method acts which are not listed. Further, one or more of the method acts may be performed once or repeatedly. Further, two or more of the method acts may be performed simultaneously or in a timely overlapping fashion. The method may at least partially be computer-implemented.

The method may further comprise act a1) denoted with reference numeral 142. Act a1) may be performed before act a). Act a1) may comprise receiving at least one element of information on a failure of the non-programmable hardware element 118 by using the arbiter 124. Act a1) may further comprise using at least one of start-up diagnostics and on-the-fly diagnostics. Thus, act a1) may overall comprise receiving at least one element of information on a failure of the non-programmable hardware element 118 by using the arbiter 124 and at least one of start-up diagnostics and on-the-fly diagnostics. The method may further comprise act a2) denoted with reference numeral 144. Act a2) may be performed before act a). Act a2) may comprise defining at least one critical failure. At least one of acts a) and b) may be performed only in case of the critical failure. The critical failure may be selected from the group consisting of: a safety related failure; a failure of a high availability non-programmable hardware element 118. Specifically, the critical failure may be a safety related failure of a high availability non-programmable hardware element 118. As already indicated, the arbiter 124 may at least partially be comprised by the programmable hardware element 120, specifically by the standby entity 122. Thus, at least one of acts a) and b) may be performed by using the programmable hardware element 120, specifically by using the standby entity 122.

The method may further comprise act b1) denoted with reference numeral 146. Act b1) may be performed before act b). Act b1) may comprise programming the standby entity with a programmable function for replacing the non-programmable function provided by the non-programmable hardware element 118. The programming may comprise at least one of software programming and hardware programming. The programming may comprise receiving a least one software program from at least one memory, such as the internal memory 126 or the external memory 134. The programming may comprise installing the software program, specifically on the programmable hardware element 120. The method may further comprise act b2) denoted with reference numeral 148. Act b2) may be performed before act b). Act b2) may comprise receiving the programmable function for replacing the non-programmable function from the internal memory 126. The method may further comprise act b3) denoted with reference numeral 150. Act b3) may be performed before act b). Act b3) may comprise receiving the programmable function for replacing the non-programmable function from the external memory 134 via the external memory interface. The electronic device may comprise at least one GPIO. The method may further comprise act b4) denoted with reference numeral 152. Act b4) may be performed before act b). Act b4) may comprise receiving the programmable function for replacing the non-programmable function from the external memory 134 via the GPIO. The electronic device 110 may comprise at least one LVDS. The method may further comprise act b5) denoted with reference numeral 154. Act b5) may be performed before act b). Act b5) may comprise receiving the programmable function for replacing the non-programmable function from the external memory 134 via the LVDS. The electronic device 110 may comprise at least one SerDes. The method may further comprise act b6) denoted with reference numeral 156. Act b6) may be performed before act b). Act b6) may comprise receiving the programmable function for replacing the non-programmable function from the external memory 134 via the SerDes. Acts b1) to b6) may be performed additionally or alternatively to each other. The subset and/or the sequence of acts b1) to b6) may be defined based on a specific application. Other options may generally also be feasible.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

What is claimed is:

1. An electronic device comprising:
a plurality of non-programmable hardware elements, each non-programmable hardware element being configured for providing at least one non-programmable function;
a programmable hardware element configured for providing a programmable function, wherein the programmable hardware element comprises a standby entity, wherein the standby entity is configured for providing a programmable function for replacing non-programmable functions of at least two non-programmable hardware elements; and
an arbiter configured for deactivating the non-programmable hardware element and for activating the standby entity for replacing the non-programmable function provided by the non-programmable hardware element with the programmable function.

2. The electronic device according to claim 1, wherein the electronic device is a microcontroller.

3. The electronic device according to claim 1, wherein the non-programmable hardware elements are configured for providing at least partially diverse non-programmable functions.

4. The electronic device according to claim 1, wherein the programmable function is a software function or a hardware function.

5. The electronic device according to claim 1, wherein the standby entity is software programmable or hardware programmable.

6. The electronic device according claim 1, wherein the standby entity comprises at least a part of the programmable hardware element.

7. The electronic device according to claim 1, wherein the standby entity is a standby element, specifically a unified standby element.

8. The electronic device according to claim 7, wherein the programmable hardware element comprises at least one processor separate from the standby element.

9. The electronic device according to claim 1, wherein the standby entity is selected from the group consisting of: a central processing unit (CPU) or at least a part thereof; a field programmable gate array (FPGA) or at least a part thereof; a graphic processing unit (GPU) or at least a part thereof; a programmable state machine or at least a part thereof; a software program.

10. The electronic device according to claim 1, wherein the non-programmable hardware elements are selected from the group consisting of: a hardware accelerator; an input/output interface (IO interface).

11. The electronic device according to claim 1, wherein the arbiter is configured for activating a programming of the standby entity with the programmable function.

12. The electronic device according to claim 1, wherein the arbiter is configured for activating the standby entity only in case of a critical failure, wherein the critical failure is selected from the group consisting of: a safety related failure; a failure of a high availability non-programmable hardware element.

13. The electronic device according claim 1, wherein the arbiter is at least partially comprised by the standby entity.

14. An embedded system comprising an electronic device, the electronic device comprising:
a plurality of non-programmable hardware elements, each non-programmable hardware element being configured for providing a non-programmable function;
a programmable hardware element configured for providing a programmable function, wherein the programmable hardware element comprises a standby entity, wherein the standby entity is configured for providing a programmable function for replacing the non-programmable functions of at least two non-programmable hardware elements; and
an arbiter configured for deactivating a non-programmable hardware element and for activating the standby entity for replacing the non-programmable function provided by the non-programmable hardware element with the programmable function;
wherein the embedded system further comprises: a further device controlled by the electronic device.

15. The embedded system according to claim 14, wherein, in normal operation, the non-programmable hardware element of the plurality of non-programmable hardware elements of the electronic device, wherein, in fault operation, the further device is controlled by using the programmable function provided by the standby entity.

16. A method for operating an electronic device, the method comprising the following acts performed by an arbiter of the electronic device:
a) deactivating a non-programmable hardware element of the electronic device; and
b) activating a standby entity of a programmable hardware element of the electronic device for replacing at least one non-programmable function provided by the non-programmable hardware element with at least one programmable function provided by the standby entity.

17. The method according to claim 16, further comprising performing act a1) before act a), wherein act a1) comprises receiving an element of information on a failure of the non-programmable hardware element by using the arbiter.

18. The method according to claim 17, further comprising act performing act a2) before act a), wherein act a2) comprises defining a critical failure, wherein at least one of acts a) and b) is performed only in case of the critical failure.

19. The method according to claim 18, further comprising performing act b1) before act b), wherein act b1) comprises programming the standby entity with a programmable function for replacing the non-programmable function provided by the non-programmable hardware element, wherein the programming comprises at software programming or hardware programming.

20. A use of the electronic device according to claim 14 for a purpose of use selected from the group consisting of: an automotive application; a medical application, specifically an implant; a remote-controlled application; an industry application.
